(19) United States
(12) Patent Application Publication
(10) Pub. No.: US 2026/0266500 A1
(43) Pub. Date: Sep. 10, 2026

(54) VENTILATION SYSTEM

(71) Applicant: LG ELECTRONICS INC., Seoul (KR)

(72) Inventors: Donghyun PARK, Seoul (KR); Jiyeon CHOI, Seoul (KR); Kyungjung LEE, Seoul (KR); Sangrak KIM, Seoul (KR); Sooyeon SHIN, Seoul (KR)

(21) Appl. No.: 19/428,696

(22) Filed: Dec. 22, 2025

(30) Foreign Application Priority Data
Mar. 10, 2025 (KR) 10-2025-0030831

(51) Int. Cl. F24F 11/89; F24F 11/77; F24F 12/00; F24F 13/20

(52) U.S. Cl. CPC F24F 11/89; F24F 11/77; F24F 12/001; F24F 13/20

(57) ABSTRACT

The present disclosure relates to a heat recovery ventilation system. A ventilation system according to an embodiment of the present disclosure comprises a case into which outdoor air and room air flows, an exhaust air fan disposed inside the case to discharge air to an outdoor side, a supply air fan disposed inside the case to discharge air to an indoor side, a total heat exchanger disposed inside the case to exchange heat between outdoor air and room air, and a control box disposed inside the case to control the exhaust air fan and the supply air fan.

### CROSS-REFERENCE TO RELATED APPLICATION

The present application claims priority to Korean Patent Application No. 10-2025-0030831, filed March 10, 2025, the entire contents of which are incorporated herein for all purposes by this reference.

### TECHNICAL FIELD

The present disclosure relates to a ventilation system, and more particularly, to a heat recovery ventilation system.

### DESCRIPTION OF RELATED ART

A ventilation system is a device that exhausts polluted room air to the outdoor side and supplies fresh outdoor air to the indoor side, thereby maintaining the freshness of room air at a certain level.

Heat recovery ventilation systems, which reduce energy loss by recovering waste heat, are commonly used in general homes, and these heat recovery ventilation systems are provided with a total heat exchanger exchanging heat between polluted room air and fresh outdoor air in order to recover waste heat.

There are many cases in which such ventilation system is installed on the ceiling of a utility room, a laundry room, or an outdoor unit room. In this case, there may be a washing machine, a dryer, a refrigerator, an outdoor unit, or various other appliances under the ventilation system. Because of this, there were many cases in which it was difficult to remove the control box for maintenance of the total heat exchanger.

### Prior Art Documents

### Patent Documents

(Patent Document 1) KR 10-1250062 B1 on 27 March 2013.

(Patent Document 2) KR 10-1190496 B1 on 5 October 2012.

(Patent Document 3) KR 10-2009-0078184 A on 17 July 2009.

### Disclosure of the Invention

### Problems to be Solved

The problem that the present disclosure seeks to solve is to provide a ventilation system whose control box can be easily removed.

The present disclosure may have other purposes besides the aforementioned one, which are clearly recognizable to a person skilled in the art from the description below.

### Means of solving the Problems

In order to achieve the object, a ventilation system according to an embodiment of the present disclosure comprises a case into which outdoor air and room air flow, an exhaust air fan disposed inside the case to discharge air to an outdoor side, a supply air fan disposed inside the case to discharge air to an indoor side, a total heat exchanger disposed inside the case to exchange heat between outdoor air and room air, a control box disposed inside the case to control the exhaust air fan and the supply air fan.

In order to achieve the object, a ventilation system according to an embodiment of the present disclosure comprises a case, a total heat exchanger disposed inside the case to exchange heat between outdoor air and room air, an exhaust air fan disposed inside the case to discharge room air, which is heat-exchanged in the total heat exchanger, to an outdoor side, and a supply air fan disposed inside the case to discharge outdoor air, which is heat-exchanged in the total heat exchanger, to an indoor side, a door to open or close a lower side of the case, and a control box disposed inside the case to control the exhaust air fan and the supply air fan, wherein the control box is separable from the case upon opening of the door.

Specific details of other embodiments are included in the detailed description and drawings.

### Advantageous Effects

According to the ventilation system of the present disclosure, one or more of the following effects are achieved.

First, it has the advantage that the control box can be removed downward, making maintenance easy.

Second, it has the advantage that the control box can be disposed inside the case without obstructing airflow because the control box is disposed between the outdoor air flow path and the ventilation flow path.

Third, it has the advantage that it is possible to prevent the control box cover from not being installed because the hook of the door is configured to be combined with the control box cover covering the control box.

Fourth, it has the advantage that it is possible to prevent the control box from falling downward because the control box cover is configured to be partially press-fitted into the case.

The present disclosure can provide other effects besides the ones described above, which are clearly recognizable to a person skilled in the art from the claims.

### DESCRIPTION OF DRAWINGS

FIG. 1 is a perspective view of a ventilation system according to an embodiment of the present invention.

FIG. 2 is an exploded perspective view of a ventilation system according to an embodiment of the present disclosure.

FIG. 3 is a drawing illustrating the removal of components of a ventilation system according to an embodiment of the present disclosure.

FIG. 4 is an internal structural diagram of a ventilation system according to an embodiment of the present disclosure.

FIG. 5 is a drawing showing the opening of a door of a ventilation system according to an embodiment of the present disclosure.

FIG. 6 is a drawing illustrating the removal of a control box of a ventilation system according to an embodiment of the present disclosure.

FIG. 7 is a perspective view of a control box cover of a ventilation system according to an embodiment of the present disclosure.

### DETAILED DESCRIPTIONS

Advantages and features of the present disclosure, and a method of achieving the advantages and features will become apparent when referring to the following embodiments described later in detail together with the accompanying drawings. However, the present disclosure is not limited to the embodiments as disclosed below, but may be embodied in various different forms. Thus, these embodiments are set forth only to make the present disclosure complete, and to completely inform the scope of the present disclosure to those of ordinary skill in the technical field to which the present disclosure belongs. Throughout the detailed description, like reference numerals refer to like components.

Although the terms "first", "second", and so on are used to describe various components, these components are not limited by these terms. These terms are merely used to distinguish one component from another component, and unless specifically stated to the contrary, it should be understood that a first component may also be a second component.

Throughout the specification, unless specifically stated to the contrary, each element may be singular or plural.

Hereinafter, the phrase “any configuration is disposed in the upper side of (or in the lower side of) a component" or “on (or below) a component" may mean not only that any configuration is disposed in contact with the upper surface (or lower surface) of said component, but also that another configuration may be interposed between said component and any configuration disposed on (or below) said component.

Additionally, when a component is described as being "connected," "coupled," or "contacted" to another component, it should be understood that although the both components may be directly connected, coupled or contacted to each other, a third component may also be "interposed" between the both components, or the both components may be "connected," "coupled," or "contacted" to each other through a third component.

As used herein, singular expressions include plural expressions unless the context clearly dictates otherwise. Herein, the terms “be comprised of” or “comprise” should not be construed to necessarily include all of the various components or various steps described in the specification, and should be construed to mean that some of the components or some of the steps may not be included, or that additional components or steps may be included.

Throughout the disclosure, the phrase “A and/or B” means A, B, or A and B, unless otherwise specified, and the phrase “C to D” means equal to or greater than C and equal to or smaller than D unless otherwise specified.

Hereinafter, the present disclosure will be described with reference to drawings for explaining a ventilation system according to embodiments of the present disclosure.

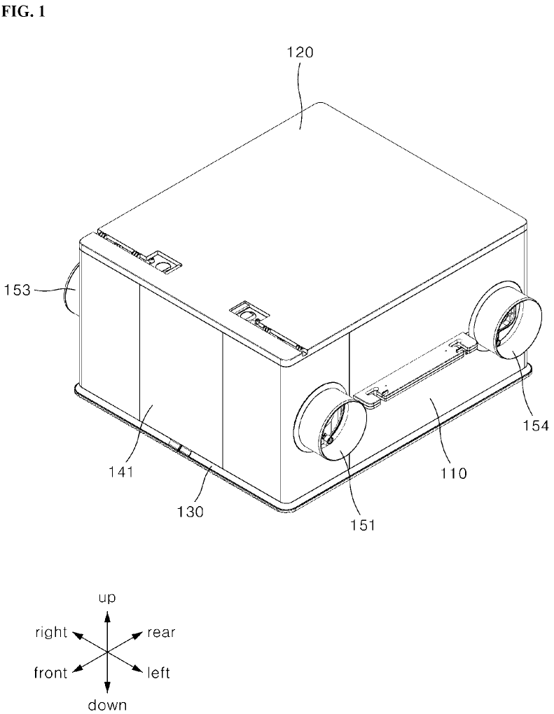

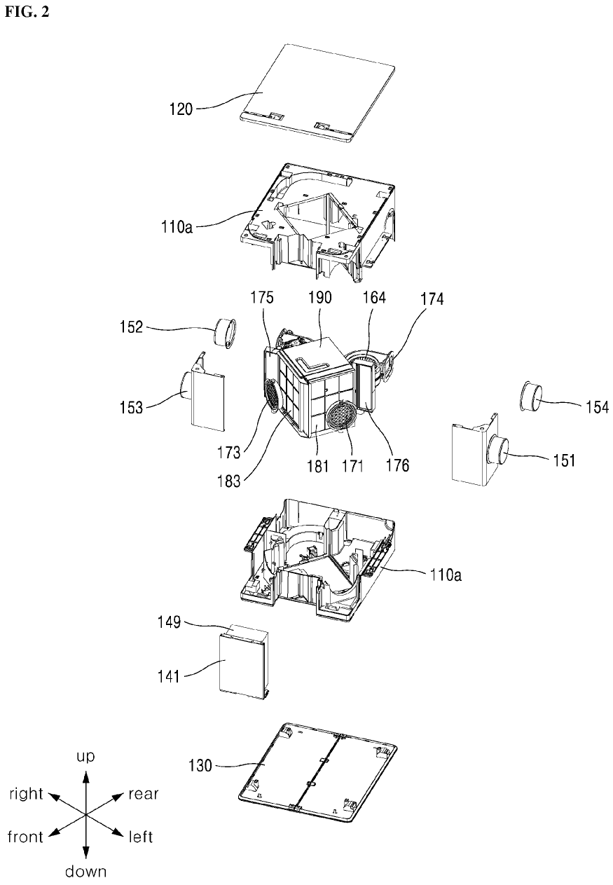

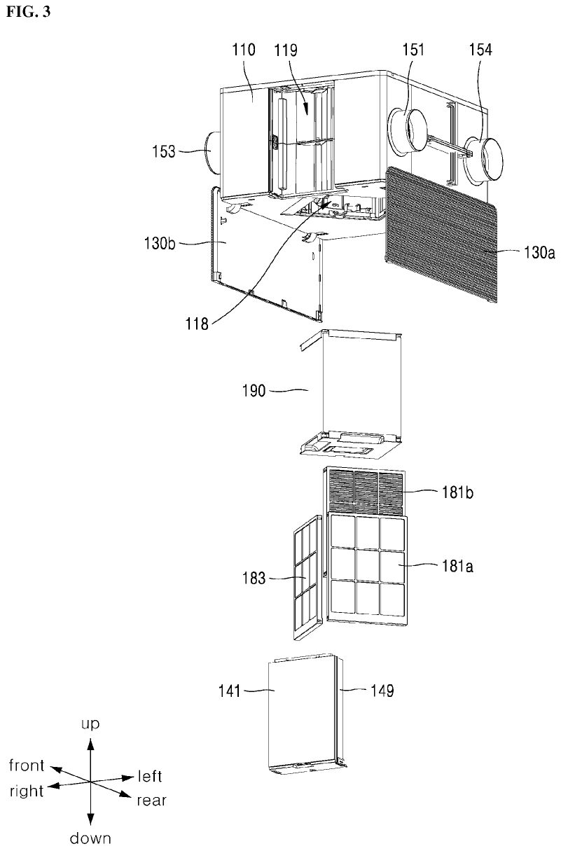

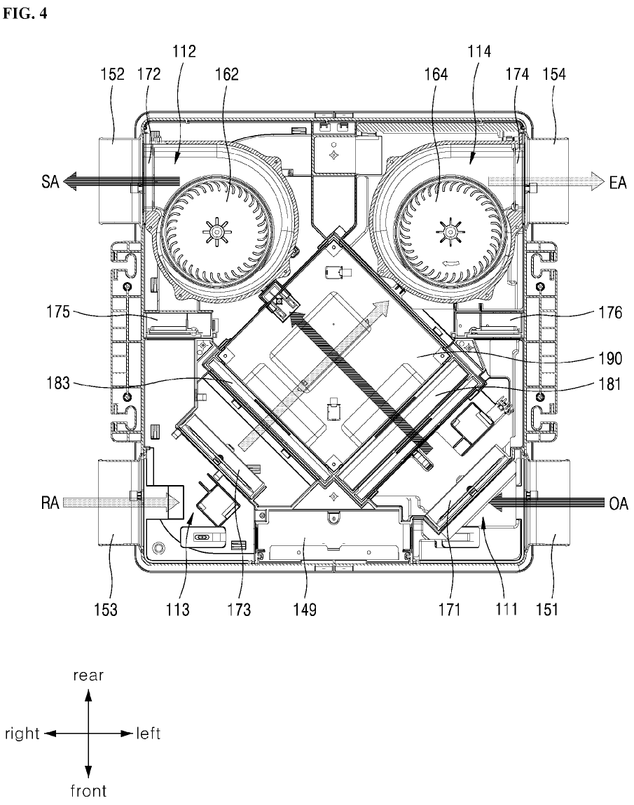

FIG. 1 is a perspective view of a ventilation system according to an embodiment of the present disclosure, FIG. 2 is an exploded perspective view of a ventilation system according to an embodiment of the present disclosure, FIG. 3 is a drawing illustrating the removal of components of a ventilation system according to an embodiment of the present disclosure, and FIG. 4 is an internal structural diagram of a ventilation system according to an embodiment of the present disclosure.

A ventilation system according to an embodiment of the present disclosure comprises a case 110 forming the exterior and into which outdoor air and room air flow, a door 130 rotatably coupled to the lower side of the case 110, a case cover 120 covering the upper surface of the case 110, an exhaust air fan 164 disposed inside the case 110 to discharge air to the outside, a supply air fan 162 disposed inside the case 110 to discharge air to the indoor side, a total heat exchanger 190 disposed in the internal center of the case 110 to exchange heat between outdoor air and room air, a control box 149 disposed inside the case 110 to control the exhaust air fan 164 and the supply air fan 162, and a control box cover 141 coupled to the case 110 to cover the control box 149.

The case 110 has a substantially rectangular parallelepiped shape and forms the exterior of the ventilation system. The case 110 has a space formed therein in which air flow paths and various parts are installed. The case 110 comprises an upper case 110a forming the upper portion and a lower case 110b forming the lower portion.

The case 110 has four flow paths formed therein through which air flows. Referring to FIG. 4, the case 110 has the following flow paths formed therein: an outdoor air flow path 111 through which air introduced from the outdoor side (outdoor air) flows; an exhaust air flow path 114 through which air to be discharged to the outdoor side flows; a ventilation flow path 113 through which air introduced from the indoor side (room air) flows; and a supply air flow path 112 through which air to be discharged to the indoor side flows.

The case 110 has a central receiving space 118 formed therein in which a total heat exchanger 190, an outdoor air filter 181, and a ventilation filter 183 are received. The central receiving space 118 is disposed to be surrounded by the outdoor air flow path 111, the exhaust air flow path 114, the ventilation flow path 113, and the supply air flow path 112. Referring to FIG. 3, the lower side of the central receiving space 118 is open, so that the total heat exchanger 190, the outdoor air filter 181, and the ventilation filter 183 can be separated downward upon opening of the door 130.

The case 110 has an outer receiving space 119 recessed into the outer side so as to receive a control box 149. The outer receiving space 119 is disposed between the outdoor air flow path 111 and the ventilation flow path 113. Referring to FIG. 3, the lower side of the outer receiving space 119 is open, so that the control box 149 and the control box cover 141 can be separated downward upon opening of the door 130.

In the case 110, an exhaust air fan 164, a supply air fan 162, an outdoor air damper 171, a ventilation damper 173, a bypass damper 175, a circulation damper 176, an exhaust air damper 174, and a supply air damper 172. On the outer sides of the case 110, an outdoor air flange 151, a ventilation flange 153, an exhaust air flange 154, a supply air flange 152, and a control box cover 141 are disposed. On the upper side of the case 110, a case cover 120 is disposed, and on the lower side thereof, the door 130 is disposed.

The case cover 120 covers the upper surface of the case 110 and forms the exterior upper surface. The case cover 120 has a rectangular plate shape and is coupled to the upper side of the case 110. Between the case cover 120 and the case 110 an insulating material may be provided.

The door 130 opens or closes the lower side of the case 110. The door 130 completely covers the lower surface of the case 110 when closed or completely expose the lower surface of the case 110 when opened. The door 130 opens or closes the open lower side of the central receiving space 118, so that when opened, the total heat exchanger 190, the outdoor air filter 181, and the ventilation filter 183 can be separated downward. The door 130 opens or closes the open lower side of the outer receiving space 119, so that when opened, the control box 149 and the control box cover 141 can be separated downward.

The door 130 may be provided in plural, and, in the present embodiment, comprises a left door 130a disposed in the side of the outdoor air flange 151 and the exhaust air flange 154, and a right door 130b disposed in the side of the ventilation flange 153 and the supply air flange 152.

The exhaust air fan 164 is disposed in the exhaust air flow path 114 on the left rear in the case 110. The exhaust air fan 164 discharges room air, which is introduced through the ventilation flange 153 and then heat-exchanged in the total heat exchanger 190, to the outdoor side. The exhaust air damper 174 is disposed at the discharge port of the exhaust air fan 164. The discharge port of the exhaust air fan 164 is connected with the exhaust air flange 154. The circulation damper 176 is provided in front of the exhaust air fan 164, and the supply air fan 162 is disposed on the right side of the exhaust air fan 164.

The supply air fan 162 is disposed in the supply air flow path 112 on the right rear in the case 110. The exhaust air fan 162 discharges outdoor air, which is introduced through the outdoor air flange 151 and then heat-exchanged in the total heat exchanger 190, to the indoor side. The supply air damper 172 is disposed at the discharge port of the supply air fan 162. The discharge port of the supply air fan 162 is connected with the supply air flange 152. The bypass damper 175 is provided in front of the supply air fan 162, and the exhaust air fan 164 is disposed on the left side of the supply air fan 162.

The total heat exchanger 190 is disposed in the central receiving space 118 in the center of the case 110. The total heat exchanger 190 is disposed to be surrounded by the outdoor air flow path 111, the exhaust air flow path 114, the ventilation flow path 113, and the supply air flow path 112. The outdoor air filter 181 is disposed on the front left side of the total heat exchanger 190; the ventilation filter 183 is disposed on the front right side thereof; the exhaust air fan 164 is disposed on the rear left side thereof; and the supply air fan 162 is disposed on the rear right side thereof. The total heat exchanger 190 can be removed downward from the case 110 upon opening of the door 130.

The total heat exchanger 190 exchanges heat between outdoor air flowing from the outdoor air flow path 111 to the supply air flow path 112 and room air flowing from the ventilation air flow path 113 to the exhaust air flow path 114. The total heat exchanger 190 comprises a plurality of liners and a plurality of spacers forming a plurality of intersecting flow paths so that outdoor air and room air can flow crossing each other.

The control box 149 is disposed in the outer receiving space 119 at the front center in the case 110. The control box 149 is disposed between the outdoor air flow path 111 and the ventilation flow path 113. The control box 149 is disposed between the outdoor air flange 151 and the ventilation flange 153. The outdoor air flange 151 is disposed in the left side of the control box 149, the ventilation flange 153 is disposed in the right side thereof, and the control box cover 141 is disposed in the front side thereof. The control box 149 is coupled to the case 110 and can be separated downward from the case 110 upon opening of the door 130.

In the control box 149, there are provided electronic components such as a printed circuit board, an integrated circuit, and the like. The control box 149 controls the outdoor air damper 171, the ventilation damper 173, the bypass damper 175, the circulation damper 176, the exhaust air damper 174, the supply air damper 172, the exhaust air fan 164, and the supply air fan 162, while supplying power to them.

The control box cover 141 is disposed in the front center of the case 110. The control box cover 141 is an L-shaped panel covering the front surface and the lower surface of the control box 149. The control box cover 141 shields the outer receiving space 119. The control box cover 141 covers the control box 149 to protect the control box 149. The control box cover 141 forms the exterior side surface together with the side surface of the case 110. The control box cover 141 is detachably coupled to the side surface of the case 110. The control box cover 141 can be separated downward from the case 110 upon opening of the door 130.

A ventilation system according to an embodiment of the present disclosure further comprises the outdoor air damper 171 disposed in the outdoor air flow path 111 to allow or stop the inflow of outdoor air, the ventilation damper 173 disposed in the ventilation flow path 113 to allow or stop the inflow of room air, the exhaust air damper 174 disposed in the exhaust air fan 164 to allow or stop the discharge of air, the supply air damper 172 disposed in the supply air fan 162 to allow or stop the discharge of air, the bypass damper 175 guiding room air in the ventilation flow path 113 to the exhaust path 114 when opened, the circulation damper 176 guiding room air in the exhaust path 114 to the outdoor air flow path 111 when opened, the outdoor air flange 151 connected with an outdoor air duct extending outdoors to allow outdoor air to be introduced thereinto, the ventilation flange 153 connected with a ventilation duct extending indoors to allow room air to be introduced thereinto, the exhaust air flange 154 connected with an exhaust air duct extending outdoors to allow air to be discharged to the outdoor side, the supply air flange 152 connected with a supply air duct extending indoors to allow air to be discharged to the indoor side, the outdoor air filter 181 purifying air introduced through the outdoor air flow path 111, and the ventilation filter 183 purifying air introduced into the ventilation flow path 113.

The outdoor air damper 171 is disposed in the outdoor air flow path 111 on the front left in the case 110. The outdoor air damper 171 is disposed between the outdoor air flange 151 and the total heat exchanger 190 to allow or stop the flow of air introduced from the outdoor side or to adjust the air volume thereof.

The ventilation damper 173 is disposed in the ventilation flow path 113 on the front right in the case 110. The ventilation damper 173 is disposed between the ventilation flange 153 and the total heat exchanger 190 to allow or stop the flow of air introduced from the indoor side or to adjust the air volume thereof.

The exhaust air damper 174 is disposed in the exhaust air flow path 114 on the rear left in the case 110. The exhaust air damper 174 is disposed at the discharge port of the exhaust air fan 164 to allow or stop the flow of air discharged from the exhaust air fan 164 to the outdoor side or to adjust the air volume thereof. The exhaust air damper 174 allows or stops the inflow of air from the outdoor side.

The supply air damper 172 is disposed in the supply air flow path 112 on the rear right in the case 110. The supply air damper 172 is disposed at the discharge port of the supply air fan 162 to allow or stop the flow of air discharged from the supply air fan 162 to the indoor side or to adjust the air volume thereof. The supply air damper 172 allows or stops the inflow of air from the indoor side.

The bypass damper 175 is disposed on the center right in the case 110. The bypass damper 175 is disposed between the ventilation flow path 113 and the supply air flow path 112 to guide air from the ventilation flow path 113 to the exhaust path 114 when opened.

The circulation damper 176 is disposed at the left center in the case 110. The circulation damper 176 is disposed between the exhaust path 114 and the outdoor air flow path 111 to guide air from the exhaust path 114 to the outdoor air flow path 111 when opened.

The external flange 151 is disposed on the front left outside of the case 110. The outdoor air flange 151 guides air introduced from the outdoor side to the outdoor air flow path 111. The outer flange 151 protrudes toward the left but may protrude toward the front depending on an embodiment.

The ventilation flange 153 is disposed on the front right outside of the case 110. The ventilation flange 153 guides air introduced from the indoor side to the ventilation flow path 113. The ventilation flange 153 protrudes toward the right but may protrude toward the front depending on an embodiment.

The exhaust air flange 154 is disposed on the rear left outside of the case 110. The exhaust air flange 154 guides air discharged from the exhaust air fan 164 to the outdoor side.

The supply air flange 152 is disposed on the rear right outside of the case 110. The supply air flange 152 guides air discharged from the supply air fan 162 to the indoor side.

The outdoor air filter 181 is disposed in the outdoor air flow path 111 on the front left in the case 110. The outdoor air filter 181 is disposed between the outdoor air damper 171 and the total heat exchanger 190 to purify air introduced from the outdoor side. The outdoor air filter 181 may be a variety of filters removing odors or harmful substances or filtering out fine substances, and in this embodiment, the outdoor filter 181 comprises an outdoor air dust filter 181a filtering out fine substances and an outdoor air deodorizing filter 181b removing odors, as shown in FIG. 3.

The ventilation filter 183 is disposed in the ventilation flow path 113 on the front right in the case 110. The ventilation filter 183 is disposed between the ventilation damper 173 and the total heat exchanger 190 to purify air introduced from the indoor side. The ventilation filter 183 may be a variety of filters removing odors or harmful substances or filtering out fine substances, and in this embodiment, the ventilation filter 183 is a dust filter filtering out fine substances.

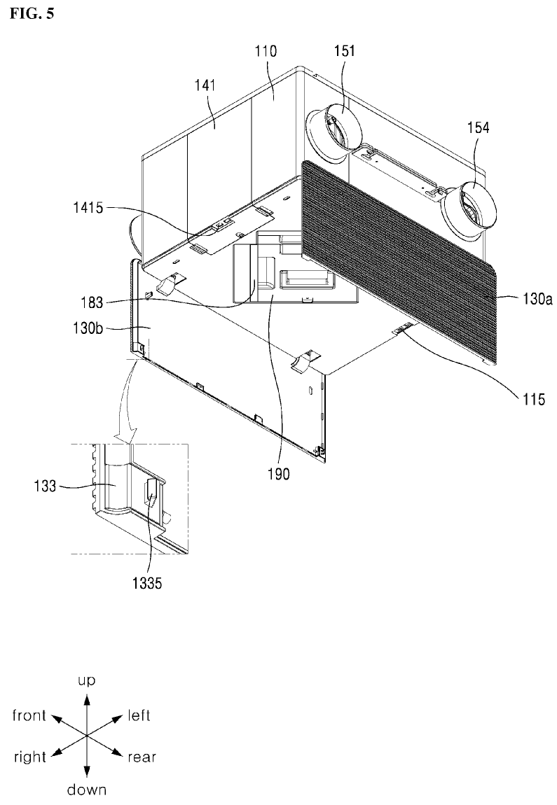

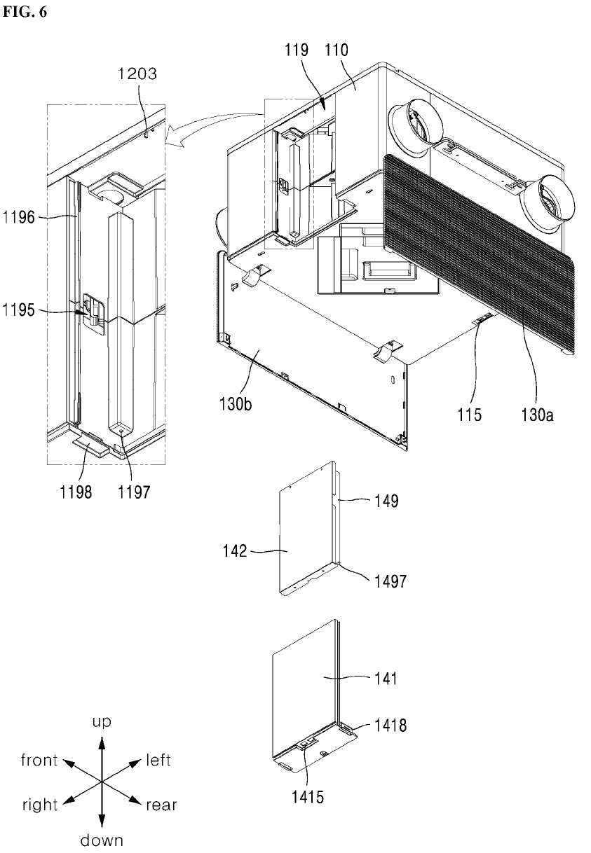

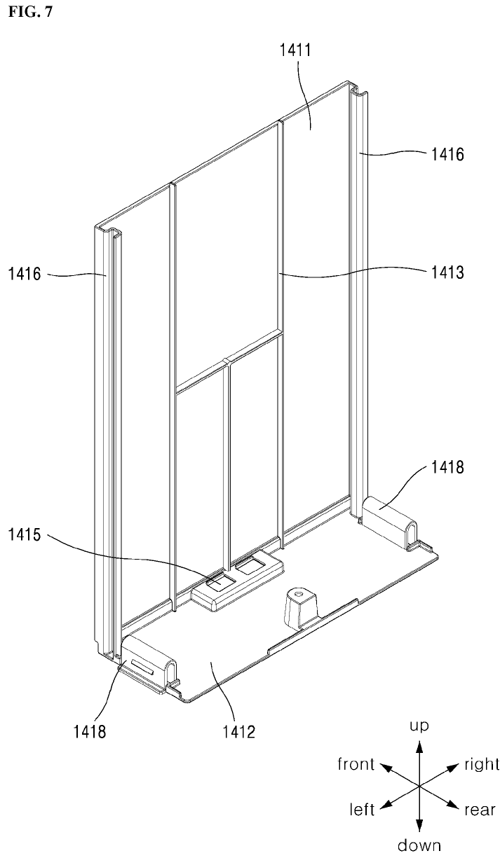

FIG. 5 is a drawing showing the opening of the door of a ventilation system according to an embodiment of the present disclosure, FIG. 6 is a drawing illustrating the removal of a control box of a ventilation system according to an embodiment of the present disclosure, and FIG. 7 is a perspective view of a control box cover of a ventilation system according to an embodiment of the present disclosure.

Referring to FIG. 5, the door 130 comprises a door button 133 unlocking the door 130 to be opened when operated (pressed). The door button 133 comprises a door hook 1335 shaped to be latched on the lower surface of the control box cover 141 or the lower surface of the case 110.

A pair of door buttons 133 are provided on one door 130, and the pair of door buttons 133 are provided on the front and rear ends of the door 130, respectively. The door hook 1335 of the door button 133 disposed at the front end of the door 130 is latched by the door keeper 1415 of the control box cover 141, and the door hook 1335 of the door button 133 disposed at the rear end of the door 130 is latched by the case keeper 115 of the case 110. Some of the door buttons 133 are latched by the door keeper 1415 of the control box cover 141, so the door 130 cannot be completely closed in a state where the control box cover 141 is separated from the case 110. Accordingly, it is possible to prevent the door 130 from being closed without fastening the control box cover 141.

Referring to FIG. 6, the ventilation system according to an embodiment of the present disclosure further comprises a shielding panel 142, which is an electromagnetic compatibility (EMC) panel made of a metal material, blocks electromagnetic waves, and is disposed between the control box 149 and the control box cover 141. The control box 149 has control box bosses 1497, each being formed to protrude from the lower end to a side and be coupled with the case 110 by a fastening means such as a bolt.

Referring to FIG. 7, the control box cover 141 has a cover side surface portion 1411 forming a portion of the exterior side of the ventilation system and covering the front surface of the control box 149, a cover lower surface portion 1412 formed to extend horizontally from the lower end of the cover side surface portion 1411 and covering the lower surface of the control box 149, slide rails 1416 respectively formed to be recessed lengthwise in the up and down direction on opposite side ends (left and right side ends) of the cover side surface portion 1411, the door keeper 1415 disposed in the center of the cover lower surface portion 1412 and on which the door hook 1335 of the door button 133 is latched, cover snap hooks 1418 respectively disposed on opposite side ends (left and right side ends) of the cover lower surface portion 1412 and latched on the lower surface of the case 110, and a cover rib 1413 formed to protrude from the rear surface of the cover side surface portion 1411 toward the control box 149 to separate the shielding panel 142 from the cover side surface portion 1411.

When the door 130 is closed, by the door 130, the cover lower surface portion 1412 is completely covered, and the cover snap hooks 1418 are also covered. Thereby, when the door 130 is closed, the cover snap hooks 1418 cannot be operated, and thus the control box 149 cannot be separated. That is, when the door 130 is opened, the cover snap hooks 1418 are exposed so that the control box cover 141 and the control box 149 can be separated, and thus it is possible to prevent unintended separation of the control box 149.

Referring to FIG. 6, the case 110 has a control box vent hole 1195 formed therein to communicate the outdoor air flow path 111 (or ventilation flow path 113) with the outer receiving space 119 in which the control box 149 is received, slide guides 1196 inserted into the slide rails 1416 and protruding lengthwise in the up and down direction, case bosses 1197 protruding into the outer receiving space 119 to be coupled with the control box bosses 1497 by fastening means, case sockets 1198 disposed on the lower surface of the case 110 and being open so that the cover snap hooks 1418 are latched thereon, and the case keeper 115 disposed at the rear end center of the lower surface of the case 110 and on which the door hooks 1335 of the door buttons 133 are latched.

The slide guide 1196 is formed so that the widths at the upper end and the lower end are greater than the width at the center. The slide guide 1196 is partially press-fitted into the slide rail 1416 to prevent the control box cover 141 from being easily separated from the case 110.

The case cover 120 has an L-shaped case cover rib 1203 formed to protrudes downward and rearward from the inside of the front edge to separate the shielding panel 142 from the case cover 120.

While the preferred embodiments of the present disclosure have been illustrated and described above, the present disclosure is not limited to the specific embodiments described above, and, rather, various modifications or changes can be made to the preferred embodiments by those skilled in the art without departing from the scope of the present disclosure as claimed in the claims, and thus these modified embodiments should not be understood as being separate from the technical idea or prospect of the present disclosure.

What is claimed is:

1. A ventilation system comprising:
a case into which outdoor air and indoor air flow;
an exhaust air fan disposed inside the case to discharge air to an outdoor side;
a supply air fan disposed inside the case to discharge air to an indoor side;
a total heat exchanger disposed inside the case to exchange heat between outdoor air and room air; and
a control box disposed inside the case to control the exhaust air fan and the supply air fan.

2. The ventilation system of claim 1, wherein the case has an outdoor air flow path through which outdoor air flows, and a ventilation flow path through which room air flows; and
wherein the control box is disposed between the outdoor air flow path and the ventilation flow path.

3. The ventilation system of claim 2, wherein the case has a control box vent hole formed therein to communicate the outdoor air flow path with a space in which the control box is received.

4. The ventilation system of claim 1, further comprising:
an outdoor air flange disposed outside the case into which outdoor air flows; and
a ventilation flange disposed outside the case into which room air flows,
wherein the control box is disposed between the outdoor air flange and the ventilation flange.

5. The ventilation system of claim 1, further comprising:
a control box cover coupled to the case to cover the control box.

6. The ventilation system of claim 5, further comprising:
a door rotatably coupled to a lower side of the case,
wherein the control box cover is separable downward from the case upon opening of the door.

7. The ventilation system of claim 6, wherein the door comprises a door button to unlock the door to be opened; and
wherein the control box cover has a door keeper formed therein, by which the door button is latched.

8. The ventilation system of claim 7, wherein the case has a case keeper disposed on a lower surface thereof,
wherein the door button is provided as a pair of door buttons; and
wherein one of the pair of door buttons is latched on the door keeper and another of the pair of door buttons is latched on the case keeper.

9. The ventilation system of claim 6, wherein the control box cover has a cover snap hook formed to be latched on a lower surface of the case; and
wherein the cover snap hook is exposed upon opening of the door.

10. The ventilation system of claim 5, wherein the control box cover has a slide rail on a side end thereof formed to be recessed lengthwise in an up and down direction,
wherein the case has a slide guide formed to protrude lengthwise in the up and down direction and be inserted into the slide rail; and
wherein the slide guide has widths at an upper end and a lower end thereof greater than a width at a center thereof.

11. The ventilation system of claim 10, wherein the case has a case socket formed to be disposed on a lower surface thereof and be open so that the cover snap hook is latched thereon.

12. The ventilation system of claim 5, further comprising:
a shielding panel disposed between the control box and the control box cover to block electromagnetic waves,
wherein the control box cover has a cover rib formed to protrude toward the control box to separate the shielding panel therefrom.

13. The ventilation system of claim 1, wherein the control box has a control box boss formed to protrude from a lower end thereof to a side and be coupled with the case by a fastening means.

14. The ventilation system of claim 13, wherein the case has a case boss formed to protrude into a space, in which the control box is received, to be coupled with the control box boss by the fastening mean.

15. A ventilation system comprising:
a case;
a total heat exchanger disposed inside the case to exchange heat between outdoor air and room air;
an exhaust air fan disposed inside the case to discharge room air, which is heat-exchanged in the total heat exchanger, to an outdoor side;
a supply air fan disposed inside the case to discharge outdoor air, which is heat-exchanged in the total heat exchanger, to an indoor side;
a door to open or close a lower side of the case; and
a control box disposed inside the case to control the exhaust air fan and the supply air fan, wherein the control box is separable from the case upon opening of the door.
